(19) United States
(12) Patent Application Publication
(10) Pub. No.: US 2014/0197149 A1
(43) Pub. Date: Jul. 17, 2014

(54) TORCH ADJUSTMENT APPARATUS

(71) Applicants: Satoshi Ohta, Tokyo (JP); Kiyoshi Dezuno, Toyko (JP); Yoshiki Todate, Toyko (JP); Tetsuo Koike, Toyko (JP)

(72) Inventors: Satoshi Ohta, Tokyo (JP); Kiyoshi Dezuno, Toyko (JP); Yoshiki Todate, Toyko (JP); Tetsuo Koike, Toyko (JP)

(21) Appl. No.: 14/129,913

(22) PCT Filed: Jun. 19, 2012
(86) PCT No.: PCT/JP2012/065638

§ 371 Date: Mar. 25, 2014

(30) Foreign Application Priority Data
Jun. 27, 2011 (JP) 2011-141305

(51) Int. Cl. B23K 9/12

(52) U.S. Cl. CPC B23K 9/126
USPC 219/138

(57) ABSTRACT

[Problem] To provide a torch adjustment apparatus that improves anti-heat measures while making it easy to set the angle of the torch. [Solution] Provided is a torch adjustment apparatus for adjusting the position of a torch in relation to the material to be processed. The apparatus has the following: a torch holder (27) that supports the torch so that the torch is detachable; a torch angle adjustment unit that adjusts the angle of the torch holder in relation to the material to be processed; and a torch in and out adjustment unit that adjusts the in and out position of the torch holder by moving the holder on a plane parallel to the material to be processed in a direction perpendicular to the traveling direction of the carriage (B). The torch holder is formed in a channel shape comprising a pair of flanges (27a and 27b) and a connecting piece (27c) that connects the pair of flanges. A mounting member (28) for mounting the torch so that the torch is detachable is disposed on the connecting piece, and the torch holder is mounted to the torch angle adjustment unit via one of the flanges (27a).

### TECHNICAL FIELD

The present invention relates to a torch adjustment apparatus for adjusting in relation to a material to be processed a position and an angle of a welding torch or a cutting torch mounted on a carriage that travels on top of the material to be processed.

### BACKGROUND ART

In a case of fillet-welding an intersection of two large-sized steel plates arranged perpendicularly, a carriage that mounts a welding torch, can travel on the steel plate arranged horizontally, and guides a surface of the steel plate arranged vertically is used (for example, refer to Patent Literature 1). Also, in a case of cutting a steel plate or a stainless steel plate, a carriage that mounts a gas cutting torch or a plasma cutting torch and travels on the steel plate or the stainless steel plate is used in some cases.

In a case of welding or cutting with use of the carriage mounted and traveling on a material to be processed, strong heat is applied from the torch to a part to be processed to fuse or burn the part to be processed in the steel plate. As a result, since the carriage is heated as well, by radiation of the applied heat, a heat-insulating plate is provided over an approximately entire surface of the carriage on a side on which the torch is arranged.

Also, in a case of the fillet welding, a position in a horizontal direction, a position in a height direction, and an angle of the welding torch need to be adjusted so that the welding torch may head for the intersection of the steel plates accurately. Similarly, in a case of cutting the steel plate, a position in a horizontal direction, a position in a height direction, and an angle corresponding to an angle of targeted cutting (for example, an angle corresponding to vertical cutting or groove cutting of the steel plate) of the cutting torch need to be adjusted.

To this end, a normal carriage including the carriage described in Patent Literature 1 is provided with a torch adjustment apparatus for adjusting the position and the angle of the welding torch or the cutting torch. The torch adjustment apparatus is configured to include an in and out adjustment member including a screw shaft or a rack provided on a plane parallel to the material to be processed in a direction perpendicular to a traveling direction of the carriage, an elevation member including a screw shaft or a rack whose in and out movement is adjusted by this in and out adjustment member and that is provided approximately in a vertical direction to the material to be processed, and a torch holder mounted turnably to this elevation member.

The torch such as the welding torch or the cutting torch is mounted to the torch holder, and by respectively operating the in and out adjustment member and the elevation member, in and out movement of the torch and a height of the torch from the material to be processed are adjusted, and by setting a mounting angle of the torch holder in relation to the elevation member, the angle of the torch is adjusted.

### CITATION LIST

### Patent Literature

Patent Literature 1: JP 3400290 B1

### SUMMARY OF INVENTION

### Technical Problem

The above carriage mounting the welding torch or the cutting torch is provided with the heat-insulating plate for insulating radiation heat at the time of processing the material to be processed, and it is required to take more effective anti-heat measures.

Also, there is an actual demand for an adjustment apparatus making it easy to set the angle of the torch in relation to the material to be processed.

An object of the present invention is to provide a torch adjustment apparatus that improves anti-heat measures while making it easy to set an angle of a torch.

### Solutions to Problem

To solve the above problems, a torch adjustment apparatus according to the present invention is one for adjusting a position of a torch in relation to a material to be processed, the torch including a welding torch or a cutting torch mounted on a carriage that travels on top of the material to be processed, and includes a torch holder that supports the torch so that the torch may be detachable, a torch angle adjustment unit that adjusts an angle of the torch holder in relation to the material to be processed, and a torch in and out adjustment unit that adjusts an in and out position of the torch holder by moving the holder on a plane parallel to the material to be processed in a direction perpendicular to a traveling direction of the carriage, wherein the torch holder is formed in a channel shape including a pair of flanges and a connecting piece that connects the pair of flanges, a mounting member for mounting the torch so that the torch may be detachable is disposed on the connecting piece, and the torch holder is mounted to the torch angle adjustment unit via one of the flanges.

In the torch adjustment apparatus, the torch in and out adjustment unit is preferably configured to include a shaft member arranged on the plane parallel to the material to be processed in the direction perpendicular to the traveling direction of the carriage and a bracket driven by the shaft member to be configured to enable reciprocating movement and provided at a predetermined position with a turning shaft, the torch angle adjustment unit is preferably configured to include a turning member turnably mounted to the turning shaft provided in the bracket and provided at a position away from the turning shaft with a nut member and a screw member arranged turnably in the bracket approximately in a vertical direction to the material to be processed and screwed in the nut member provided in the turning member, and the torch holder is preferably mounted to the turning member via one of the flanges.

### Advantageous Effects of Invention

In the torch adjustment apparatus according to the present invention, since the torch holder is formed in a channel shape including the pair of flanges and the connecting piece, and the mounting member for mounting the torch is disposed on the connecting piece, the torch is surrounded in three directions by the pair of flanges and the connecting piece. Thus, part of heat generated from a welded portion or a cut portion can be insulated by the torch holder. Accordingly, it is possible to prevent part of the heat from transmitting to the carriage, which can improve anti-heat measures.

Also, the torch angle adjustment unit is configured to include the turning member turnably mounted to the turning shaft provided in the bracket and provided at the position away from the turning shaft with the nut member and the screw member arranged turnably in the bracket approximately in the vertical direction to the material to be processed and screwed in the nut member provided in the turning member. The torch holder is mounted to the turning member via one of the flanges. Thus, by rotating the screw member arranged in the bracket, the turning member can be turned, centering on the turning shaft. The torch holder turns along with turning of the turning member, and the torch mounted to the mounting member provided on the torch holder also turns. Accordingly, an angle of the torch in relation to the material to be processed can be adjusted easily.

### BRIEF DESCRIPTION OF DRAWINGS

FIGS. 1(a) and 1(b) are a front view and a left side view illustrating configurations of a carriage and a torch adjustment apparatus.

FIGS. 2(a) and 2(b) are the front view and a right side view illustrating configurations of the carriage and the torch adjustment apparatus.

FIGS. 3(a) and 3(b) are the front view and a plan view illustrating configurations of the carriage and the torch adjustment apparatus.

FIG. 4 illustrates a configuration of a main part of a torch holder.

FIGS. 5(a) and 5(b) illustrate states when a torch is raised and lowered by the torch adjustment apparatus.

### DESCRIPTION OF EMBODIMENTS

Hereinafter, a configuration of a torch adjustment apparatus A according to an embodiment of the present invention and a configuration of a carriage B having the torch adjustment apparatus A will be described with reference to the drawings. In the present embodiment, the carriage B is configured as a carriage for welding adapted to weld two not-illustrated steel plates. Especially, one of the two steel plates is arranged horizontally while the other is arranged to erect, and the carriage B is configured to enable application of fillet welding to a part in which the two steel plates intersect. Thus, a not-illustrated welding torch is mounted to the torch adjustment apparatus A, and to this welding torch are connected hoses such as a hose that supplies gas and a hose through which a weld line passes.

However, the torch to be mounted is not limited to the welding torch but may be a cutting torch such as a gas cutting torch and a plasma cutting torch. In a case where such a cutting torch is selected and mounted, mechanisms and members specific to the selected cutting torch such as a valve mechanism adapted to supply gas and a relay member of a cabtyre cable for electric conduction are mounted on predetermined positions of the carriage B.

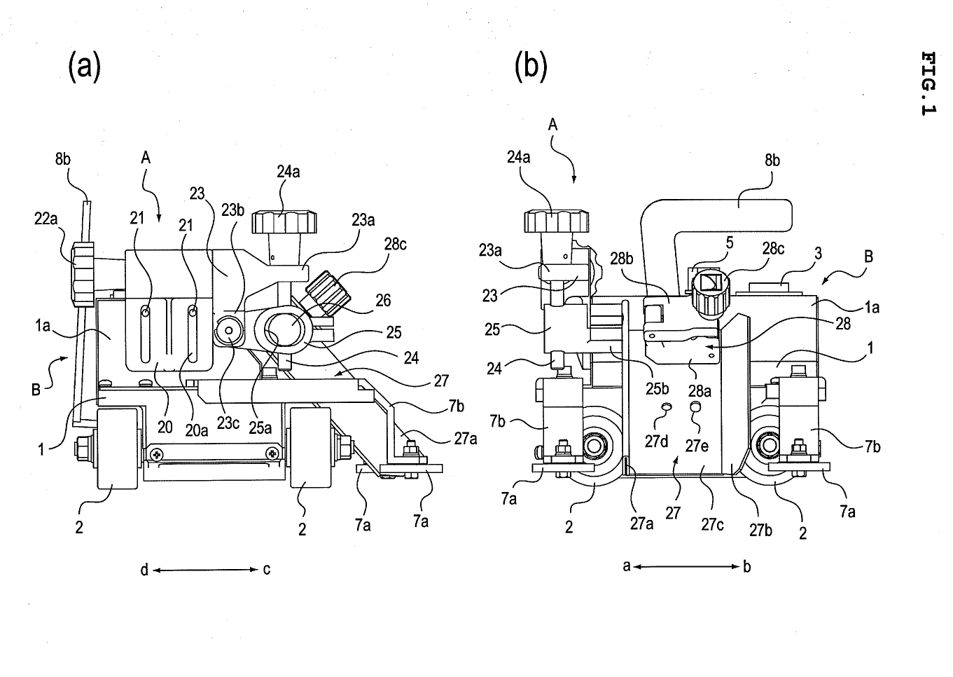

First, a configuration of the carriage B will be described briefly. The carriage B illustrated in FIGS. 1 to 3 is configured to enable to travel in arrows a and b directions (hereinafter, the arrow a direction is referred to as a front direction while the arrow b direction is referred to as a back direction in some cases) and is configured to enable to execute targeted welding by driving the not-illustrated welding torch in the process of this travel.

The carriage B has a casing 1 covered with a cover 1a at an upper portion thereof and closed by a bottom plate at a lower portion thereof, and a not-illustrated driving motor and a control unit controlling the driving motor are incorporated in the casing 1.

On both sides in a front-back direction as a traveling direction of the casing 1 are rotatably arranged a plurality of wheels 2. At least one of the wheels 2 is configured as a driving wheel driven by a driving motor while the other wheels 2 are configured as driven wheels. However, how many wheels 2 act as driving wheels is not limited, and two wheels or four wheels may be configured as driving wheels.

On an upper surface of the cover 1a are provided a socket 3 adapted to connect a power supply cord, a push-button switch 4 adapted to operate movement of the carriage B, a dial 5 adapted to adjust traveling speed of the carriage B, and an LED 6 adapted to display a movement mode of the carriage B.

On one side surface (a side surface on a side of an arrow c direction; it is hereinafter referred to as a left side surface of the carriage B in some cases while a side surface on a side of an arrow d direction is referred to as a right side surface of the carriage B in some cases) of the casing 1, arranged are guide rollers 7a at both end portions in the front-back direction, respectively. These guide rollers 7a are rotatably provided at tip ends of arms 7b respectively configured to enable expansion and contraction, and at the time of execution of fillet welding, the guide rollers 7a are configured to contact a surface of the steel plate arranged vertically to enable to guide travel of the carriage B.

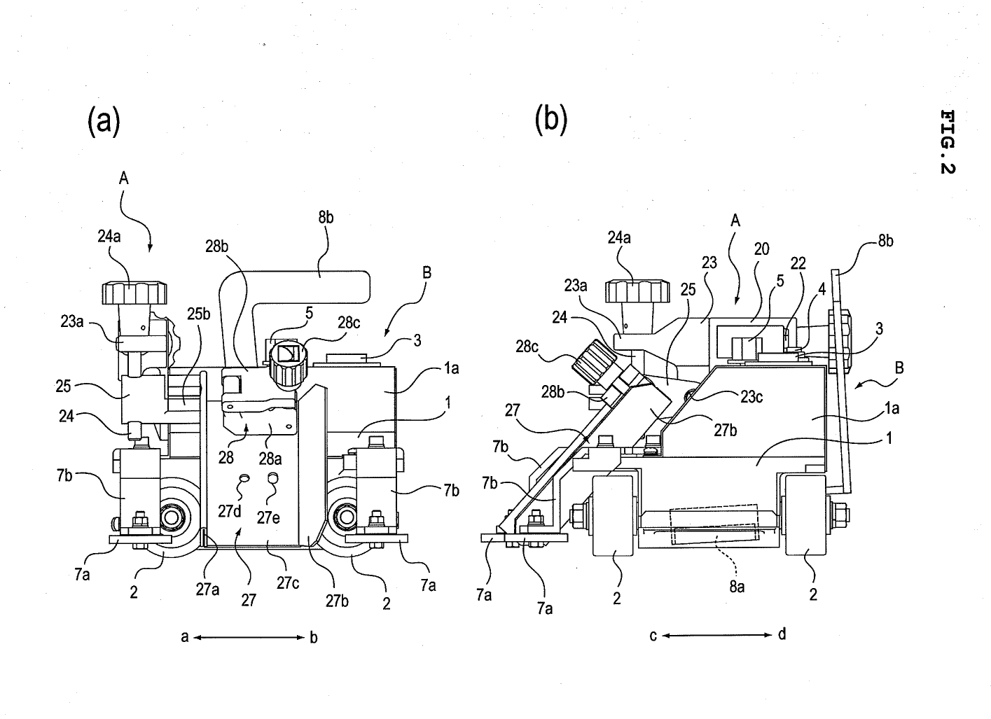

In addition, as illustrated in FIG. 2(b), in the casing 1 is arranged a magnet 8a, which is configured to enable a posture to be changed along with an operation of a handle 8b. When the magnet 8a is inclined as illustrated with a dotted line in the figure by the operation of the handle 8b, an adsorption force to the steel plate decreases to enable the carriage B to be separated from the steel plate easily. Also, when the magnet 8a is parallel to the steel plate by the operation of the handle 8b, the adsorption force becomes maximum to enable the carriage B to travel along the steel plate in a stable state.

When the carriage B configured as above is operated by pressing the push-button switch 4 in a state in which the magnet 8a is parallel to the steel plate as a material to be processed to increase the adsorption force, the carriage B starts traveling in the arrow a direction or the arrow b direction. By operating the dial 5, traveling speed of the carriage B can be adjusted.

Next, a configuration of the torch adjustment apparatus A according to the present embodiment will be described.

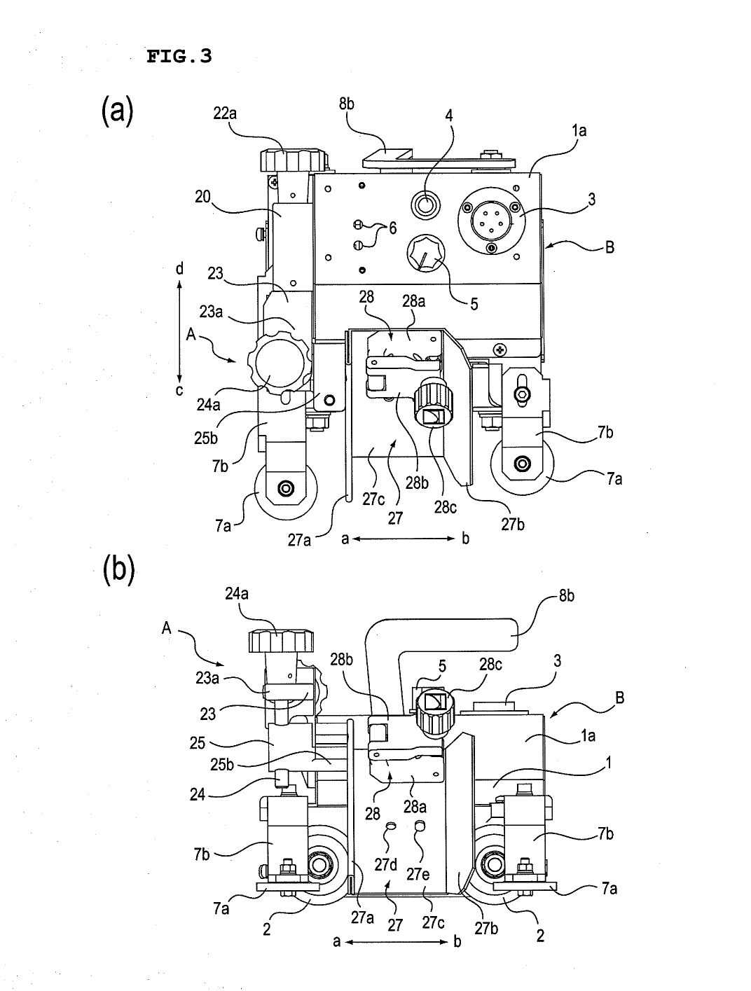

The torch adjustment apparatus A is provided at either end portion (an end portion on a front side in the present embodiment) in the front-back direction of the casing 1 constituting the carriage B and is configured so that the not-illustrated torch may be arranged on the side surface on the side of the arrow c direction approximately at a center of the carriage B. Thus, when the carriage B is seen from the side of the arrow b direction toward the side of the arrow a direction, the handle 8b operating the magnet 8a is arranged on the side of the right side surface while the torch is arranged on the side of the left side surface as illustrated in FIG. 3(a).

To an end portion on the front side of the casing 1 is mounted a mounting bracket 20 by screws 21. This mounting bracket 20 is provided with vertical elongated holes 20a, and the screws 21 are inserted in the elongated holes 20a and are fastened in the casing 1. Thus, the mounting bracket 20 is configured to enable positional adjustment in an up-down direction against the casing 1.

As illustrated in FIG. 2(b), at an upper end portion of the mounting bracket 20 is horizontally provided a screw shaft 22 as a shaft member constituting a torch in and out adjustment unit. When the mounting bracket 20 is mounted to the casing 1 constituting the carriage B, the screw shaft 22 is arranged in parallel with a line connecting centers of the wheels 2. At an end portion of the screw shaft 22 projecting from the mounting bracket 20 is fixed a handle 22a, and the screw shaft 22 is configured to enable rotation by an operation of this handle 22a. Also, in an end portion of the screw shaft 22 arranged in the mounting bracket 20 is screwed a bracket 23, which is configured to enable to move in the arrow c direction or the arrow d direction in accordance with rotation of the screw shaft 22.

It is to be noted that a shaft forming a rack can be used instead of the aforementioned screw shaft 22. In this case, a pinion is arranged in the bracket 23.

The bracket 23 is configured to include a horizontal piece 23a and a hanging piece 23b. The horizontal piece 23a is formed in an extending direction of the screw shaft 22 while the hanging piece 23b is formed to hang in a perpendicular direction from the horizontal piece 23a. Dimensions of the horizontal piece 23a and the hanging piece 23b are not particularly limited and are preferably set arbitrarily in accordance with a specification set as a welding apparatus or a cutting apparatus.

At a predetermined position of the horizontal piece 23a constituting the bracket 23 is provided a supporting portion rotatably supporting a screw member 24 constituting a torch angle adjustment unit. Also, at a predetermined position of the hanging piece 23b is horizontally arranged a turning shaft 23c turnably supporting a turning member 25 constituting a torch angle adjustment unit.

The turning member 25 is turnably supported by the turning shaft 23c provided in the hanging piece 23b of the bracket 23. Thus, the turning member 25 is configured to enable to turn in a vertical plane, centering on the turning shaft 23c. Also, the turning member 25 is provided with an elongated hole 25a at a position away from the turning shaft 23c and corresponding to the screw member 24 provided in the horizontal piece 23a, and in the elongated hole 25a is arranged a nut member 26 screwed with the screw member 24. The turning member 25 is further provided with a projecting supporting arm 25b on a surface corresponding to the back side of the carriage B at a position corresponding to the elongated hole 25a of the turning member 25.

As described above, the nut member 26 is configured to enable to move along the elongated hole 25a along with turning of the turning member 25. That is, the screw member 24 is arranged to pass through the horizontal piece 23a of the bracket 23 approximately in the vertical direction and passes through and screws in the nut member 26 in the vertical direction. When the handle 24a is operated to rotate the screw member 24, the nut member 26 is raised or lowered along with this rotation, and the turning member 25 turns, centering on the turning shaft 23c. Accordingly, a distance between a center of the nut member 26 and the turning shaft 23c changes, and this change can be absorbed by the elongated hole 25a.

Meanwhile, in the configuration in the present embodiment, although the nut member 26 moves along the elongated hole 25a provided in the turning member 25 along with rotation of the screw member 24, the present invention is hot limited to this configuration. For example, a configuration in which the nut member 26 is turnably arranged against the turning member 25 while the screw member 24 is configured to enable oscillation against the horizontal piece 23a of the bracket 23 can achieve similar operations.

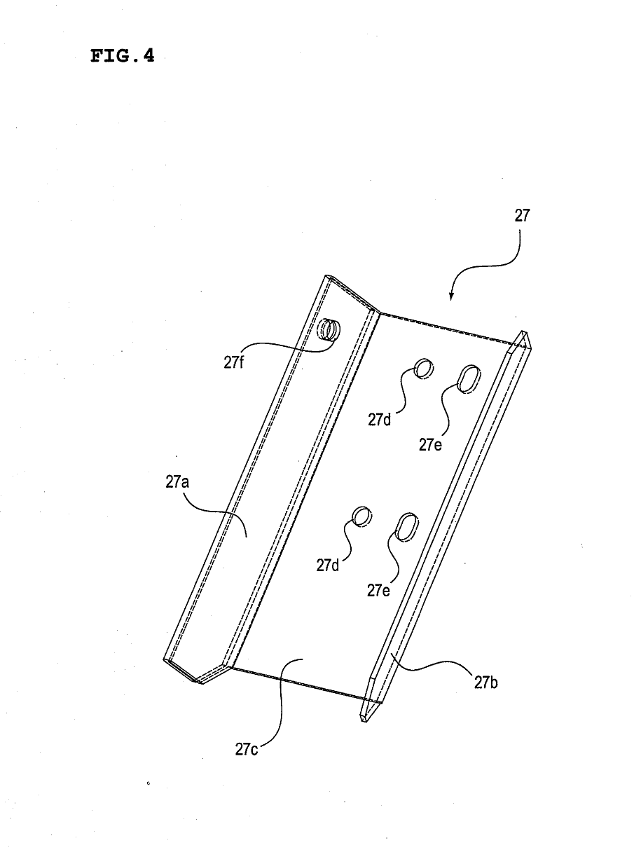

To the supporting arm 25b provided in the turning member 25 is mounted a torch holder 27. The torch holder 27 functions to support the not-illustrated welding torch or cutting torch (the welding torch in the present embodiment) and insulate radiation of heat generated at the time of welding or cutting to prevent the radiation of heat from transmitting to the carriage. As illustrated in FIG. 4, the torch holder 27 is formed in a channel shape including a pair of flanges 27a and 27b and a connecting piece 27c that connects the pair of flanges 27a and 27b.

A mounting member 28 for mounting the not-illustrated torch so that the torch may be detachable is disposed on a predetermined position of the connecting piece 27c. This mounting member 28 is configured to include a base portion 28a, a nipping portion 28b configured to be turnable against the base portion 28a and nipping the torch together with the base portion 28a, and a fixing portion 28c fixing the nipping portion 28b to the base portion 28a. By mounting the base portion 28a to the connecting piece 27c of the torch holder 27, the torch can be mounted so as to be detachable.

Thus, the connecting piece 27c is provided with holes 27d and elongated holes 27e adapted to fix the base portion 28a to be arrayed, and by inserting bolts into the hole 27d and the elongated hole 27e as a pair to fasten the base portion 28a, the mounting member 28 can be fixed. Especially, pairs each consisting of the hole 27d and the elongated hole 27e are formed in two positions at upper and lower portions of the connecting piece 27c, respectively, and the upper pair or the lower pair can be selected for fixing the mounting member 28 thereto. Accordingly, by selecting the upper or lower pair and fixing the mounting member 28 thereto, the torch can be mounted to approach to or separate from the steel plate. Also, since one is formed as the elongated hole 27e, a mounting posture can be adjusted at the time of fixing the mounting member 28 to the connecting piece 27c.

One flange 27a constituting the torch holder 27 is formed perpendicularly to the connecting piece 27c, and the torch holder 27 is mounted to the supporting arm 25b provided in the turning member 25 via the flange 27a. A structure of mounting the flange 27a to the supporting arm 25b is not particularly limited, and the flange 27a can be mounted to the supporting arm 25b with use of a not-illustrated bolt. Also, the supporting arm 25b can be formed in a half nut shape while the flange 27a can be provided with a shaft member, and the flange 27a can be mounted to the supporting arm 25b by fitting the shaft member into the half nut.

In the present embodiment, the torch holder 17 is mounted to the supporting arm 25b with use of a not-illustrated bolt. Thus, a hole 27f through which the bolt passes is formed at a predetermined position of the flange 27a. Although the circular hole 27f is formed in the flange 27a in the example illustrated in FIG. 4, a linear elongated hole or an arc-like elongated hole is preferable in some cases, and a shape of the hole 27f is not limited to a circle. Also, the hole 27f is formed at a position in the flange 27a approximately corresponding to a center of the torch to be mounted to the mounting member 28.

The torch holder 27 is formed by sheet-metal processing, and one flange 27a is formed to be double in a state of being folded outward. Thus, when the flange 27a is fastened to the supporting arm 25b by inserting the bolt into the hole 27f of the flange 27a, the folded flange 27a functions as a spring washer and can prevent the bolt from loosening.

Also, by mounting the torch holder 27 to the supporting arm 25b with use of the bolt, a mounting angle of the torch holder 27 in relation to the supporting arm 25b can be adjusted easily. That is, in a case where the torch holder 27 is mounted to the supporting arm 25b by one bolt, the angle can be adjusted by loosening the bolt. Also, in a case where the torch holder 27 is mounted to the supporting arm 25b with use of a plurality of bolts, the mounting angle of the torch holder 27 in relation to the supporting arm 25b can be adjusted by forming the hole 27f formed in the flange 27a in an arc-like elongated hole shape.

Further, a mounting position of the torch holder 27 in relation to the supporting arm 25b can be adjusted by forming a linear elongated hole in the flange 27a and mounting the flange 27a to the supporting arm 25b with use of the bolt inserted in this elongated hole. In this case, interference of a lower end portion with the steel plate along with turning of the torch holder 27 can be prevented, which is preferable.

The other flange 27b constituting the torch holder 27 is formed in a state of being inclined further outside than a perpendicular to the connecting piece 27c. Thus, the torch holder 27 is not formed in a channel shape having perpendicular flanges but in a more opened channel shape. In this manner, by inclining the flange 27b outside, it is possible to visually recognize a state of the operating torch easily.

Although height dimensions of the pair of flanges 27a and 27b constituting the torch holder 27 are not particularly limited, the pair of flanges 27a and 27b is preferably formed to wrap the torch when the torch is mounted to the mounting member 28.

Although a length of the torch holder 27 is not particularly limited, the length is preferably one enabling the lower end portion to approach a surface of the steel plate as much as possible when the torch is set at a predetermined height and at a predetermined angle in relation to the steel plate at the time of performing a targeted work. Setting the length of the torch holder 27 in this manner enables to prevent heat generated at the time of execution of welding to the steel plate from being radiated to the carriage B. However, when the torch holder 27 approaches the steel plate so much that the torch holder 27 contacts the steel plate, this may give a failure to travel of the carriage B.

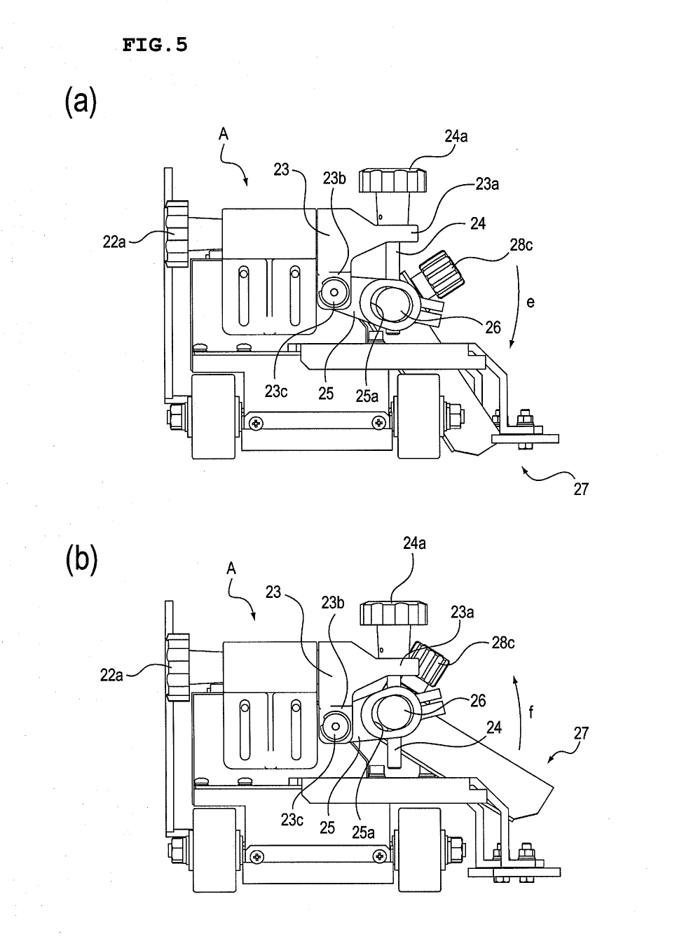

Next, a procedure of adjusting a position and an angle of the torch by the torch adjustment apparatus A configured as above will be described with reference to FIGS. 1(a) and 5.

FIG. 1(a) illustrates a state in which the nut member 26 is located approximately at a center of the elongated hole 25a provided in the turning member 25. In this state, the torch holder 27 is at a predetermined angle such as 45 degrees. Thus, the not-illustrated torch mounted to the mounting member 28 fixed on the torch holder 27 is also at an angle of 45 degrees.

In a case where the torch is moved in the arrows c and d directions while the angle of the torch is kept, that is, in a case where the carriage B is installed on the steel plate, and where a position of the torch is adjusted in the horizontal direction from a portion to be welded, the handle 22a has only to be operated to move the bracket 23 in the arrow c direction to cause the bracket 23 to project from the mounting bracket 20 or to move the bracket 23 in the arrow d direction to cause the bracket 23 to approach the mounting bracket 20.

By the above operation of the handle 22a, the bracket 23, the turning member 25, and the torch holder 27 can be moved at the same time in the arrows c and d directions, along with which the torch can be moved in the arrows c and d directions and adjusted to a desired position.

In a case where the torch is adjusted to increase the angle of the torch in relation to the steel plate (to make the torch erect further against the steel plate) from the state illustrated in FIG. 1(a), this adjustment can be achieved by rotation of the screw member 24. That is, when the screw member 24 is rotated to the left to a turning limit, for example, the turning member 25 turns in an arrow e direction as illustrated in FIG. 5(a). Along with this turning, the torch holder 27 turns as well, and the lower end portion is lowered until the lower end portion reaches a lower side than a plane including the plurality of wheels 2 while the angle in relation to the steel plate is increased. Accordingly, at the same time as turning and lowering of the torch holder 27, the torch mounted to the torch holder 27 is turned and lowered, and during this process, adjustment to a desired angle can be performed.

By turning and lowering the torch holder 27 in the above manner, the angle of the torch mounted to the torch holder 27 in relation to the steel plate can be adjusted to a predetermined angle. In a case where the lower end portion of the torch holder interferes with the steel plate along with this turning, the mounting position of the torch holder 27 in relation to the supporting arm 25b needs to be adjusted to prevent interference.

Also, in a case where the torch is adjusted to decrease the angle of the torch in relation to the steel plate (to lay the torch more against the steel plate) from the state illustrated in FIG. 1(a), when the screw member 24 is rotated to the right to a turning limit, for example, the turning member 25 turns in an arrow f direction as illustrated in FIG. 5(b). Along with this turning, the torch holder 27 turns as well, and the lower end portion is raised further upward than the plane including the plurality of wheels 2 while the angle in relation to the steel plate is decreased. Accordingly, at the same time as turning and raising of the torch holder 27, the torch mounted to the torch holder 27 is turned and raised.

By turning and raising the torch holder 27 in the above manner, the angle of the torch mounted to the torch holder 27 in relation to the steel plate can be adjusted to a predetermined angle. In a case where a distance of the torch from the steel plate increases along with turning of the torch holder 27, a mounting position of the mounting member 28 in relation to the connecting piece 27c is changed to a lower end side to enable the torch to be closer to the steel plate.

### INDUSTRIAL APPLICABILITY

The torch adjustment apparatus according to the present invention is advantageous to use not only for the carriage for welding but for a carriage for cutting.

### REFERENCE SIGNS LIST

A torch adjustment apparatus
B carriage
1 casing
1a cover
2 wheel
3 socket
4 push-button switch
5 dial
6 LED
7a guide roller
7b arm
8a magnet
8b handle
20 mounting bracket
20a elongated hole
21 screw
22 screw shaft
22a handle
23 bracket
23a horizontal piece
23b hanging piece
23c turning shaft
24 screw member
24a handle
25 turning member
25a elongated hole
25b supporting arm
26 nut member
27 torch holder
27a, 27b flange
27c connecting piece
27d, 27f hole
27e elongated hole
28 mounting member
28a base portion
28b nipping portion
28c fixing portion

1: A torch adjustment apparatus for adjusting a position of a torch in relation to a material to be processed, the torch comprising a welding torch or a cutting torch mounted on a carriage that travels on top of the material to be processed, the apparatus comprising:
a torch holder that supports the torch so that the torch may be detachable;
a torch angle adjustment unit that adjusts an angle of the torch holder in relation to the material to be processed; and
a torch in and out adjustment unit that adjusts an in and out position of the torch holder by moving the holder on a plane parallel to the material to be processed in a direction perpendicular to a traveling direction of the carriage,
wherein the torch holder is formed in a channel shape comprising a pair of flanges and a connecting piece that connects the pair of flanges, a mounting member for mounting the torch so that the torch may be detachable is disposed on the connecting piece, and the torch holder is mounted to the torch angle adjustment unit via one of the flanges.

2. The torch adjustment apparatus according to claim 1, wherein the torch in and out adjustment unit is configured to include a shaft member arranged on the plane parallel to the material to be processed in the direction perpendicular to the traveling direction of the carriage and a bracket driven by the shaft member to be configured to enable reciprocating movement and provided at a predetermined position with a turning shaft,
wherein the torch angle adjustment unit is configured to include a turning member turnably mounted to the turning shaft provided in the bracket and provided at a position away from the turning shaft with a nut member and a screw member arranged turnably in the bracket approximately in a vertical direction to the material to be processed and screwed in the nut member provided in the turning member, and
wherein the torch holder is mounted to the turning member via one of the flanges.

3. The torch adjustment apparatus according to claim 2, wherein a handle is fixed at an end portion of the shaft member, and by an operation of the handle, the turning member is turned via the bracket, the nut member, and the screw member to adjust an angle of the torch.

4. The torch adjustment apparatus according to claim 2, wherein the nut member moves along an elongated hole of the turning member along with turning of the turning member.

5. The torch adjustment apparatus according to claim 1, wherein the torch in and out adjustment unit is configured to include a shaft member arranged on the plane parallel to the material to be processed in the direction perpendicular to the traveling direction of the carriage and a bracket driven by the shaft member to be configured to enable reciprocating movement and provided at a predetermined position with a turning shaft,
wherein the torch angle adjustment unit is configured to include a turning member turnably mounted to the turning shaft provided in the bracket and provided at a position away from the turning shaft with a pinion and a rack arranged turnably in the bracket approximately in a vertical direction to the material to be processed and screwed in the pinion provided in the turning member, and
wherein the torch holder is mounted to the turning member via one of the flanges.

6. The torch adjustment apparatus according to claim 3, wherein the nut member moves along an elongated hole of the turning member along with turning of the turning member.
